(19) United States
(12) Patent Application Publication
(10) Pub. No.: US 2026/0280890 A1
(43) Pub. Date: Sep. 17, 2026

(54) Comprehensive Record Integrity Assurance with Message Digest and Digital Signature Validation

(71) Applicant: ServiceNow, Inc., Santa Clara, CA (US)

(72) Inventors: Kothuri Lakshmana Sambasiva Srinivas, Telangana (IN); Radha Krishna Reddy Singireddy, Telangana (IN); Marvin Torio, Chula Vista, CA (US)

(21) Appl. No.: 19/077,817

(22) Filed: Mar. 12, 2025

(51) Int. Cl. H04L 9/32

(52) U.S. Cl. CPC H04L 9/3236; H04L 9/3247

(57) ABSTRACT

A method includes determining a first message digest based on a plurality of related records associated with a workflow. The method includes storing the first message digest and the plurality of related records at a database and receiving a request to execute the workflow. Based on receiving the request to execute the workflow, the method includes determining a second message digest based on the plurality of related records stored at the database, validating the workflow based on the first message digest and the second message digest, and executing the workflow based on validating the workflow.

### TECHNICAL FIELD

This disclosure relates to comprehensive record integrity assurance.

### BACKGROUND

Databases and systems that store and process large amounts of data often rely on multiple interconnected records that form a complex network of information. Ensuring the integrity of these records is critical for the reliability, security, and accountability of the databases and systems. Integrity means that the records are authentic, accurate, consistent, and complete. Traditional methods typically focus on securing individual records using digital signatures. However, these methods do not capture the relationships and dependencies among the interconnected records, and do not ensure the integrity of the entire dataset. Moreover, these methods may incur significant computational and storage overhead, especially for large and dynamic datasets.

### SUMMARY

One implementation of the disclosure provides a computer-implemented method of providing comprehensive record integrity assurance. The method includes determining a first message digest based on a plurality of related records associated with a workflow and storing the first message digest and the plurality of related records at a database. The method includes receiving a request to execute the workflow. Based on receiving the request to execute the workflow, the method includes determining a second message digest based on the plurality of related records stored at the database, validating the workflow based on the first message digest and the second message digest, and executing the workflow based on validating the workflow.

Implementations of the disclosure may include one or more of the following optional features. In some implementations, the method further includes adding the first message digest to a master record associated with the workflow and signing the master record with a digital signature. Here, the digital signature may include an asymmetric key. In these implementations, the method may further include validating the digital signature of the master record based on receiving the request to execute the workflow.

Here, validating the workflow may be further based on validating the digital signature of the master record.

In some examples, each respective related record of the plurality of related records may include one or more respective field values. Here, the one or more respective field values may be stored at one or more tables. In these examples, for each respective related record of the plurality of related records, the method may further include generating a respective field value concatenation based on the one or more respective field values. Here, determining the first message digest may include generating a record concatenation based on each respective field value concatenation generated for the plurality of related records.

In some implementations, the method further includes receiving a second request to execute the workflow and, based on receiving the second request to execute the workflow, determining a third message digest based on the plurality of related records stored at the database and invalidating the workflow based on the first message digest and the third message digest. The workflow may be associated with a no-code flow diagram. In some examples, the workflow is associated with a software script.

Another implementation of the disclosure provides a system that includes data processing hardware and memory hardware storing instructions that when executed on the data processing hardware causes the data processing hardware to perform operations. The operations include determining a first message digest based on a plurality of related records associated with a workflow and storing the first message digest and the plurality of related records at a database. The operations include receiving a request to execute the workflow. Based on receiving the request to execute the workflow, the operations include determining a second message digest based on the plurality of related records stored at the database, validating the workflow based on the first message digest and the second message digest, and executing the workflow based on validating the workflow.

Implementations of the disclosure may include one or more of the following optional features. In some implementations, the operations further include adding the first message digest to a master record associated with the workflow and signing the master record with a digital signature. Here, the operations may further include validating the digital signature of the master record based on receiving the request to execute the workflow. In these implementations, validating the workflow may be further based on validating the digital signature of the master record. In some examples, each respective related record of the plurality of related records may include one or more respective field values. In these examples, the one or more respective field values may be stored at one or more tables. The operations may further include receiving a second request to execute the workflow; and, based on receiving the second request to execute the workflow, determining a third message digest based on the plurality of related records stored at the database and invalidating the workflow based on the first message digest and the third message digest.

Another implementation of the disclosure provides a computer-readable medium having instructions that, when executed by data processing hardware, causes the data processing hardware to perform operations. The operations include determining a first message digest based on a plurality of related records associated with a workflow and storing the first message digest and the plurality of related records at a database. The operations include receiving a request to execute the workflow. Based on receiving the request to execute the workflow, the operations include determining a second message digest based on the plurality of related records stored at the database, validating the workflow based on the first message digest and the second message digest, and executing the workflow based on validating the workflow.

The details of one or more implementations of the disclosure are set forth in the accompanying drawings and the description below. Other implementations, features, and advantages will be apparent from the description and drawings, and from the claims.

### DESCRIPTION OF DRAWINGS

FIG. 1A is a schematic view of an example system using a validator to generate a first message digest.

FIG. 1B is a schematic view of an example system using the validator to validate a workflow using the first message digest and a second message digest.

FIG. 1C is a schematic view of an example system using the validator to invalidate a workflow using the first message digest and the second message digest.

FIG. 2 is a schematic view of a digest generator.

FIG. 3 is a schematic view of a no-code flow diagram.

FIG. 4 is a flowchart of an example arrangement of operations for a computer-implemented method of providing comprehensive record integrity assurance.

FIG. 5 is a schematic view of an example computing device that may be used to implement the systems and methods described herein.

Like reference symbols in the various drawings indicate like elements.

### DETAILED DESCRIPTION

A no-code software environment is a platform that allows users to create and modify applications without writing code by using graphical user interfaces, drag-and-drop components, pre-built templates, and other tools. No-code software environments allow users to rapidly develop and deploy applications for various purposes, such as data analysis, business automation, web development, and more. However, no-code software environments also pose challenges for maintaining the integrity of the data that underlies the applications, especially when the data is stored and processed in databases that involve multiple interconnected records. Ensuring data integrity in such environments is important for the reliability and accuracy of the applications built on these platforms.

Interconnected records are records that have logical or functional relationships or dependencies with other records, such as parent-child, reference, or foreign key relationships. For example, a database that stores information about customers, orders, and products may have interconnected records that link each customer to their orders, and each order to the products purchased. These relationships ensure that changes in one record are accurately reflected in related records, maintaining consistency across the database. Interconnected records form a complex network of information that represents the state and history of the database and the system. Ensuring the integrity of interconnected records is important for the reliability, security, and accountability of the database and the system, as well as for the correctness and validity of the applications that use the data.

Traditional approaches for ensuring the integrity of records typically focus on securing individual records using digital signatures. However, these traditional approaches do not capture the relationships and dependencies among the interconnected records and do not ensure the integrity of the entire dataset. For example, a digital signature can verify that a record has not been tampered with, but it cannot verify that the record is consistent and complete with respect to other related records. This limitation is particularly problematic in complex systems where records are interdependent. In such systems, the integrity of one record often depends on the integrity of related records, making it important to verify the entire dataset as a whole. Moreover, these traditional approaches may incur significant computational and storage overhead, especially for large and dynamic datasets, as each record requires a separate digital signature and verification process. For instance, in a large e-commerce platform, verifying each transaction record individually would be computationally expensive and inefficient.

Accordingly, implementations herein are directed towards a validator that determines a first message digest based on a plurality of related records associated with a workflow. In some examples, a message digest represents a fixed-length numerical representation of the contents of the plurality of related records, generated by a hash function. The validator stores the first message digest and the plurality of related records at a database and receives a request to execute the workflow. Based on receiving the request to execute the workflow, the validator determines a second message digest based on the plurality of records stored at the database, validates the workflow based on the first message digest and the second message digest, and executes the workflow based on validating the workflow. This validation ensures that the data has not been altered or corrupted since the first message digest was generated.

Advantageously, by validating the workflow based on the first message digest and the second message digest, the validator verifies the relationships among the plurality of related records to validate the workflow. The validator compares the first message digest and the second message digest to determine whether the plurality of related records have been modified in any way since the first message digest was generated. The comparison ensures that any unauthorized changes or data corruption are detected before the workflow is executed. If the first message digest and the second message digest match, the validator validates the workflow and executes the workflow. If the first message digest and the second message digest do not match, the validator rejects the execution of the workflow. This rejection prevents potentially harmful or incorrect data from being processed, maintaining the integrity and reliability of the system.

Moreover, the validator may add the first message digest to a master record associated with the workflow and sign the master record with a digital signature. The master record is a record that contains information about the workflow, such as its name, description, parameters, and results. The digital signature is a cryptographic technique that authenticates the identity of the validator and the integrity of the master record. Thus, the validator may validate the workflow further based on validating the digital signature of the master record. Validation of the digital signature ensures that the first message digest, which is part of the master record, has not been tampered with. As a result, the validator may validate the workflow by only signing the master record with the digital signature instead of signing each individual related record. This reduces the computational and storage overhead, as well as the complexity of the validation process. By focusing on the master record, the system can efficiently ensure the integrity of the entire workflow without the need for extensive computational resources.

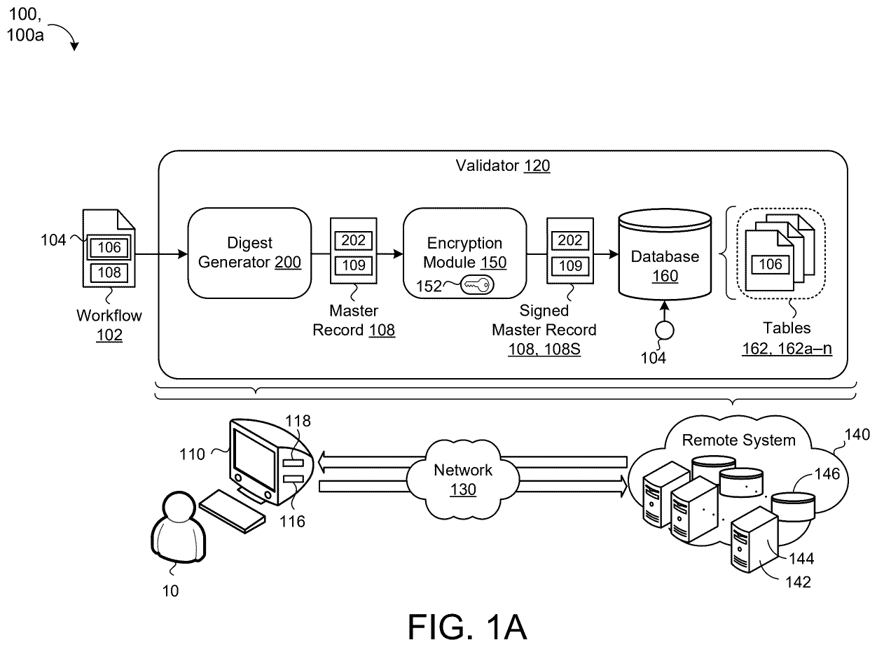

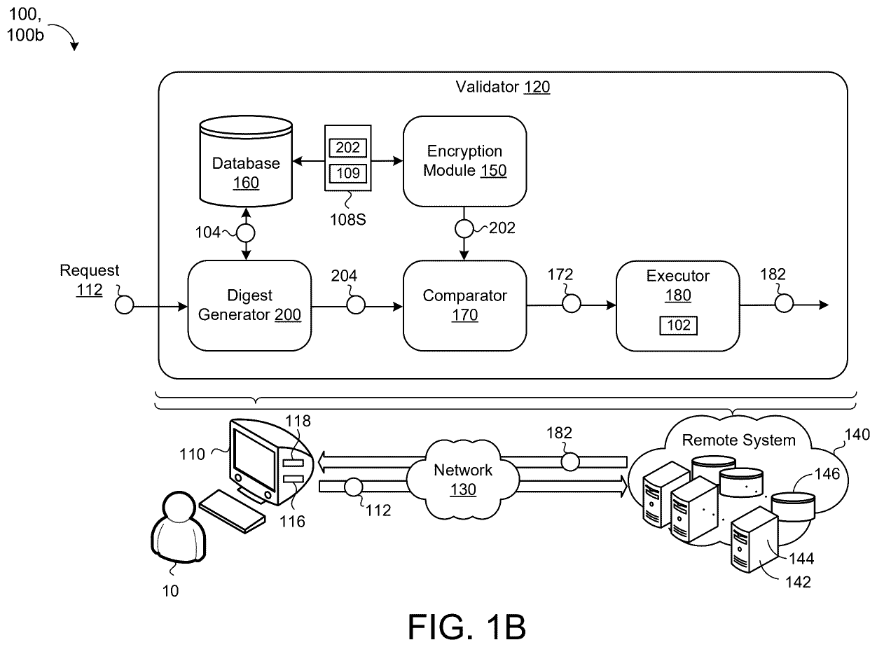

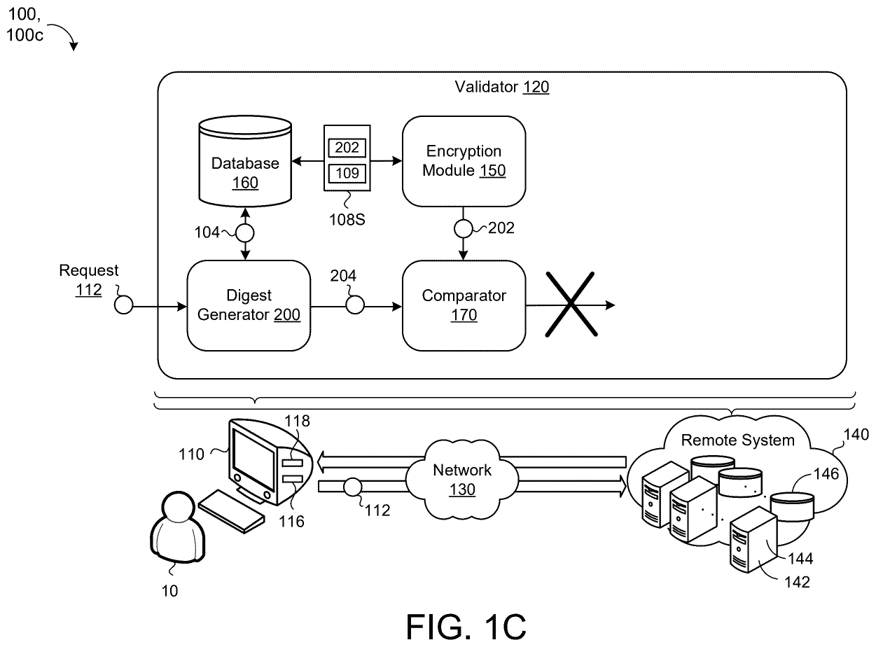

Referring to FIGS. 1A-1C, in some implementations, a system 100 includes a remote system 140 in communication with one or more user device 110 each associated with a respective user 10 via a network 130, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 110 via the network 130. The user device 110 may correspond to any computing device, such as a desktop workstation, a laptop workstation, or a mobile device (i.e., a smart phone). Each user device 110 includes computing resources 116 (e.g., data processing hardware) and/or storage resources 118 (e.g., memory hardware).

The remote system 140 and/or the user device 110 may execute a validator 120. The validator 120 is configured to validate a plurality of records 104 associated with a workflow 102 before executing the workflow 102. The validator 120 includes a digest generator 200, an encryption module 150, a database 160, a comparator 170, and an executor 180. The database 160 may be overlain on the storage resources 146 of the remote system 140. The database 160 may store one or more tables 162. Each respective table 162 may store one or more field values 106 that are associated with the plurality of related records 104. In some implementations, the plurality of related records 104 are interconnected with one another such that a change to one related record 104 may impact another related record 104. Since the related records 104 and the field values 106 may be distributed across the multiple tables 162, ensuring the integrity of the related records becomes a cumbersome process due to the interdependent nature among the plurality of related records 104.

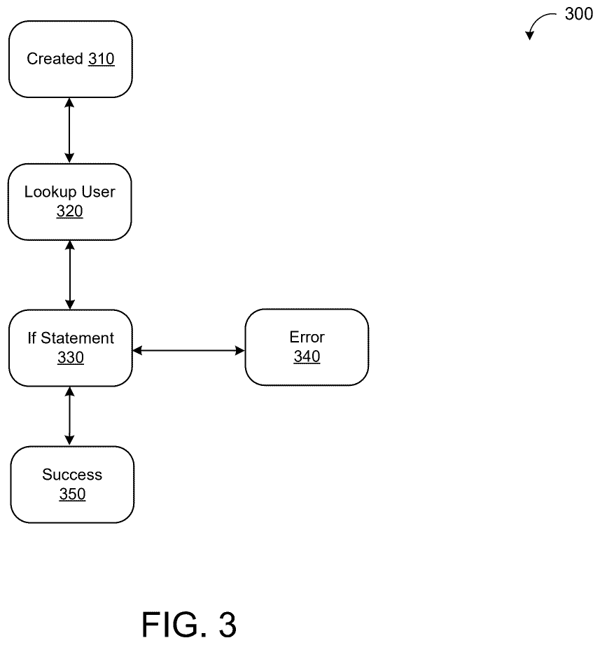

FIG. 1A illustrates a first example system 100, 100a whereby the validator 120 generates a first message digest 202. The digest generator 200 obtains a workflow 102 that is associated with a plurality of related records 104. The workflow 102 defines a sequence of actions or tasks to be performed on or with the plurality of related records 104. For instance, in an IT service management (ITSM) system, the workflow 102 may include tasks such as updating incident records, generating service performance reports, and sending notifications for scheduled maintenance. Each task in the workflow 102 is configured to ensure that the related records 104 are processed in a specific order and under certain conditions. The workflow 102 may be associated with a no-code flow diagram 300 (FIG. 3) or a software script. A no-code flow diagram 300 allows users to visually design the workflow 102 without writing any code. For instance, an IT service desk manager could use a no-code flow diagram to create a workflow for handling service requests, specifying steps such as logging the request, assigning it to the appropriate team, and tracking its resolution. On the other hand, a software script provides more flexibility and control for developers that prefer to create the workflow 102 programmatically. For example, a developer might write a script to automate the escalation of unresolved incidents after a certain period, ensuring timely attention to critical issues.

The workflow 102 specifies the logic, conditions, inputs, outputs, and dependencies of the actions or tasks. The plurality of related records 104 may be stored in one or more tables 162, 162a-n of the remote system 140. The one or more tables 162 may be located at a database 160. Each table 162 may have a schema that defines the fields, types, and constraints of the related records 104 stored therein. The related records 104 may have references or links to each other based on primary keys, foreign keys, or other identifiers of the related records 104. Each respective related record 104 of the plurality of related records 104 may include one or more respective field values 106 that store the data or metadata of the related record 104. The field values 106 may be of various types, such as strings, numbers, dates, binary data, or complex objects. The related records 104 may represent metadata, configuration, or data elements of an application, a system, or a process that are involved in or affected by the workflow 102. For example, in an ITSM system, the related records 104 may include incident details, change requests, service level agreements (SLAs), and configuration items (CIs). In other examples, the related records 104 may include flow definitions, action definitions, input scripts, output scripts, or any other records that are relevant to the workflow 102.

Notably, storing the related records 104 across the one or more tables 162 increases the complexity of verifying the integrity of the plurality of related records 104. That is, when the related records 104 are linked, dependent on each other, or part of a larger dataset, the integrity verification becomes more challenging. Traditional methods that secure individual records using digital signatures or checksums may not be capable of handling the increased complexity for verifying the integrity of the related records 104. For example, if a change is made to an incident record, the change may affect related records 104 such as problem records and change requests. In an ITSM context, updating an incident's status to “resolved” may trigger updates to related problem records 104 and initiate a change request to implement a permanent fix. Verifying the integrity of each related record 104 individually would be insufficient, as the interdependencies between related records 104 should also be checked to ensure the overall integrity of the dataset. In such cases, changes to one related record 104 may affect other related records 104, requiring a verification of the entire set of related records 104. Moreover, the relationships and dependencies between related records 104 should be preserved and verified to ensure that the workflow 102 operates correctly and that no unauthorized modifications have been made to any part of the dataset. As will become apparent, the validator 120 addresses this issue by generating a first message digest 202 and a second message digest 204 that each represent the entire set of related records 104, allowing for a comprehensive integrity check.

The digest generator 200 determines a first message digest 202 based on the plurality of related records 104 associated with the workflow 102. In some examples, the digest generator 200 determines the first message digest 202 by applying a hash function to the related records 104. The hash function may be an algorithm that produces a fixed-length output (e.g., first message digest 202) from an arbitrary-length input (e.g., plurality of related records 104). For example, the hash function may include SHA-256 or MD5. The hash function ensures that even a small change in input data, such as modifying a single character in a record, results in a completely different hash value, thereby providing a reliable means of detecting alterations. For instance, changing an address of a customer in a related record 104 would result in a different hash value, indicating that the related record 104 has been altered. In some implementations, the hash function has the property such that it is computationally infeasible to find two different inputs that produce the same output, and that any change in the input, even a single bit, results in a different output. As will become apparent, the first message digest 202 is a compact representation of the plurality of related records 104 that may be used to verify the integrity and authenticity of the plurality of related records 104.

The digest generator 200 may serialize the related records 104 into a byte stream or a string before applying the hash function. The serialization may include the table names, field names, field values, and references or links of the related records 104. The serialization may also include the order, format, and encoding of the related records 104. The serialization may ensure that the first message digest 202 is consistent and reproducible for the same set of related records 104. For example, if the related records 104 include customer data stored in multiple tables, the serialization process would convert this data into a standardized format before applying the hash function. Thus, the serialization ensures that the same set of related records 104 always produces the same message digest, regardless of how the data is stored or retrieved.

The digest generator 200 may add the first message digest 202 to a master record 108 associated with the workflow 102. The master record 108 may be a special record that stores information about the workflow 102 and the plurality of related records 104. The master record 108 may include metadata 109 of the workflow 102, such as the name, description, version, status, and timestamp of the workflow 102, as well as the identifiers, locations, and sizes of the related records 104. The master record 108 may serve as a reference point for verifying the integrity and authenticity of the workflow 102 and the related records 104. Thereafter, an encryption module 150 may sign the master record 108 with a digital signature 152 to generate a signed master record 108, 108S. In some implementations, the digital signature 152 includes an asymmetric key. Notably, the encryption module 150 signs the entire master record 108 with the digital signature 152, which includes the first message digest 202 and the metadata 109, rather than signing each individual related record 104 individually. Advantageously, signing the entire master record 108 reduces the computational and storage overhead, as signing a single master record 108 is more efficient than signing multiple individual related records 104.

The encryption module 150 may be a component that generates and verifies digital signatures 152 using cryptographic keys. For instance, the encryption module 150 may use a private key to sign the master record 108 thereby creating a digital signature that can be verified by anyone with the corresponding public key. Thus, the digital signature 152 ensures that the master record 108 has not been tampered with and confirms the authenticity of the master record 108. Ensuring that the master record 108 has not been tampered with ensures that the first message digest 202 has not been tampered with. The digital signature 152 may be a value that is derived from the master record 108 and the private key of the encryption module. The digital signature 152 may provide evidence that the master record 108 has not been tampered with and that it originates from the encryption module 150. The encryption module 150 stores the signed master record 108S, which is signed with the digital signature 152, at the database 160. The database 160 may be a secure and reliable storage system that maintains the signed master records 108S for the workflow 102 and the related records 104 of the workflow 102. The database 160 may allow authorized users or systems to access, query, or update the master records 108 and the digital signatures.

Referring now to FIGS. 1B and 1C, after storing the master record 108 at the database 160, the validator 120 receives a request 112 to execute the workflow 102. The request 112 may originate from the user 10 (e.g., via the user device 110), an application, or another system that intends to use or modify the related records 104. For example, the user 10 may initiate a request 112 to generate an incident report, which requires accessing and processing related records 104 such as incident details and resolution times. Alternatively, an automated system may send the request 112 to update configuration items based on changes implemented in the IT infrastructure. Based on receiving the request 112 to execute the workflow 102, the digest generator 200 obtains the plurality of related records 104 associated with the workflow 102 from the database 160.

The digest generator 200 determines a second message digest 204 based on the plurality of related records 104 obtained from the database 160. The plurality of related records 104 obtained should be the same as the plurality of related records 104 used to generate the first message digest 202. However, if the plurality of related records 104 have been corrupted or altered in any way, the plurality of related records 104 will be different, resulting in a different second message digest 204. The digest generator 200 determines the second message digest 204 in a similar manner as the first message digest 202. That is, the digest generator 200 may apply the hash function to the related records 104, which produces a fixed-length output from an arbitrary-length input. For example, if a patient's medical record was altered to include incorrect lab results, the second message digest 204 would differ from the first message digest 202, indicating tampering. If the plurality of related records 104 have not changed, the first message digest 202 and the second message digest 204 should be the same. However, if there is any change to the plurality of related records 104, the first message digest 202 and the second message digest 204 should be different. Notably, the comparison ensures that any unauthorized changes are detected before the workflow 102 is executed.

The comparator 170 obtains the first message digest 202 and the second message digest 204 and validates the workflow 102 therefrom. In particular, the comparator 170 compares the second message digest 204 with the first message digest 202 to determine whether the plurality of related records 104 have been altered or corrupted since the plurality of related records 104 were stored at the database 160. Put another way, the comparator 170 compares the first message digest 202 and the second message digest 204 to identify any differences. The comparison ensures that any unauthorized changes are detected before the workflow 102 is executed, maintaining integrity and reliability of the workflow 102. The comparator 170 may generate a detailed report of the validation process, highlighting any discrepancies found and providing recommendations for corrective actions.

FIG. 1B illustrates a second example system 100, 100b whereby the validator 120 validates the workflow 102. Here, the comparator 170 validates the workflow 102 by comparing the first message digest 202 with the second message digest 204 to determine that the first message digest 202 matches the second message digest 204. As such, the comparator 170 generates an indication 172 indicating to the executor 180 that the workflow 102 is valid. Based on receiving the indication 172, the executor 180 executes the workflow 102. The executor 180 generates an alert 182 based on executing the workflow 102 and sends the alert 182 to the user device 110.

In addition to, or in lieu of, validating the workflow 102 based on the first message digest 202 and the second message digest 204, the validator 120 may validate the digital signature 152 of the signed master record 108S. Here, based on receiving the request 112, the encryption module 150 may obtain the signed master record 108S from the database 160. The encryption module 150 validates the digital signature 152 of the signed master record 108S. The validation of the digital signature 152 may include using the corresponding public key to verify the digital signature 152. As such, validating the digital signature 152 ensures that the comparator 170 has the correct and verified first message digest 202 for comparison with the second message digest 204. In the example shown, the encryption module 150 validates the digital signature 152 and sends the first message digest 202 from the master record 108 to the comparator 170.

FIG. 1C illustrates a third example system 100, 100c whereby the validator 120 invalidates the workflow 102. Here, the comparator 170 invalidates the workflow 102 by comparing the first message digest 202 with the second message digest 204 to determine that the first message digest 202 does not match the second message digest 204. As such, the comparator 170 does not generate the indication 172 such that the workflow 102 is not executed by the executor 180.

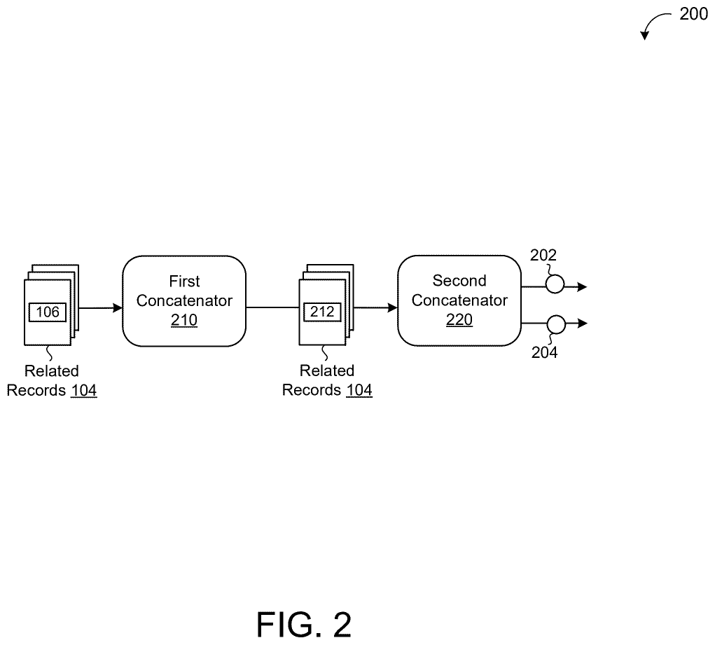

Referring now to FIG. 2, in some implementations, the digest generator 200 includes a first concatenator 210 and a second concatenator 220. As discussed above, each related record 104 of the plurality of related records 104 includes one or more respective field values 106. For each respective related record 104 of the plurality of related records 104, the first concatenator 210 generates a respective field value concatenation 212 based on the one or more respective field values 106 of the respective related record 104. The second concatenator 220 receives the respective field value concatenation 212 of each respective related record 104 and determines the corresponding message digest (e.g., first message digest 202 or second message digest 204).

For instance, if there are multiple related records 104, the second concatenator 220 concatenates the strings (e.g., field value concatenation 212) generated by the first concatenator 210 for each related record 104 into a larger string, which the second concatenator 220 uses generate the first message digest 202 or the second message digest 204. Thus, the message digest may essentially represent a concatenation of the respective field value concatenation 212 of the plurality of related records 104. By combining all field values 106 into a single string and generating the first message digest 202 or the second message digest 204 from the string, any alteration in the field values 106 of any related record 104 will result in a different message digest. This allows for the detection of unauthorized changes, ensuring the integrity and authenticity of the data.

FIG. 3 illustrates an example no-code flow diagram 300 that may be used to create a workflow 102. As described above, the workflow 102 defines a sequence of actions or tasks to be performed on or with the plurality of related records 104. The no-code flow diagram 300 allows users to visually design the workflow 102 without writing any code, by using graphical components that represent the logic, conditions, inputs, outputs, and dependencies of the actions or tasks. In the example shown, the no-code flow diagram 300 represents a workflow 102 for an example login process and has components 310, 320, 330, 340, and 350. The components may be connected by arrows or lines that indicate the flow of execution and the data transfer between the components. Each component may invoke one or more related records 104, which are associated with one or more field values 106. The components may have labels, icons, or colors that indicate their types, functions, or statuses. The components may be configurable by the user 10 enabling the user 10 to specify the parameters, values, or expressions of the components. The components may also be reusable, meaning that the user 10 may copy, paste, or drag and drop the components to create different workflows 102.

The workflow 102 in the example shown is an example only as the no-code flow diagram 300 may be used to create any workflow 102. Here, a first component 310 represents a creation component that may define the trigger events for initiating the login process. The trigger events may be user inputs, system events, or external events that cause the workflow 102 to start. The second component 320 represents a lookup user function that runs after the trigger event occurs. The lookup user function may perform a query or a search on the plurality of related records 104 to find a matching user record based on the username and the password. These related records 104 are associated with one or more field values 106, such as user names, passwords, roles, permissions, or preferences, and may be stored in one or more tables 162 of the database 160. The lookup user function may output the result of the query or the search, such as the user record or an error message, to the next component 330.

The third component 330 defines an “IF statement” that evaluates the result of the lookup user function. The condition may be an expression that compares the result of the lookup user function with a predefined value, such as a null value. For example, if the lookup user does not result in a known user being found, proceed to the fourth component 340 which indicates an error that indicates the login process has failed. Otherwise, if the look user does result in a known user being found, proceed to the fifth component 350 which indicates the login process has succeeded.

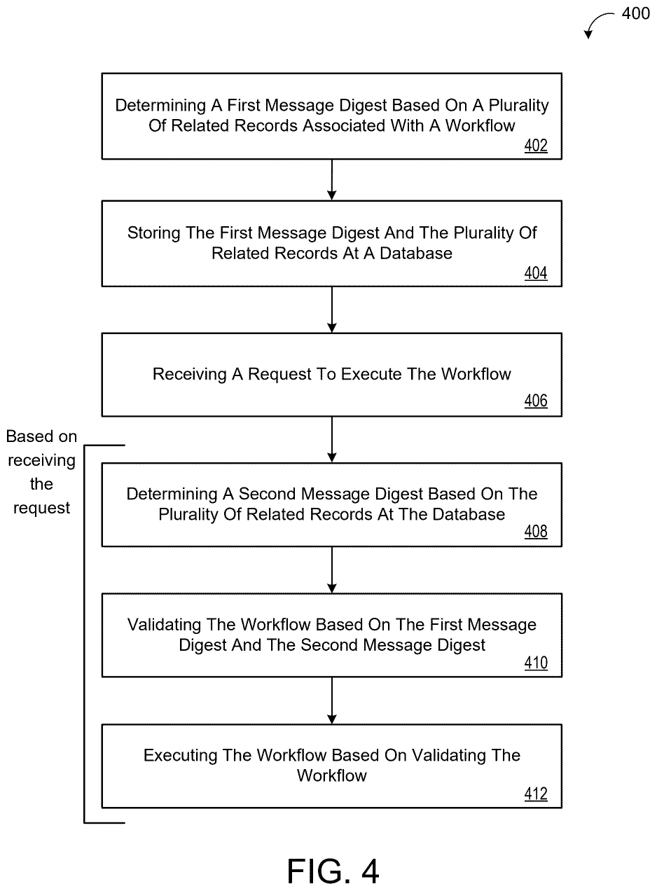

FIG. 4 is a flowchart of an exemplary arrangement of operations for a computer-implemented method 400 of providing comprehensive record integrity assurance. At operation 402, the method 400 includes determining a first message digest 202 based on a plurality of related records 104 associated with a workflow 102. At operation 404, the method 400 includes storing the first message digest 202 and the plurality of related records 104 at a database 160. At operation 406, the method 400 includes receiving a request 112 to execute the workflow 102. Based on receiving the request 112 to execute the workflow 102, the method 400 performs operations 408-412. At operation 408, the method 400 includes determining a second message digest 204 based on the plurality of related records 104 stored at the database 160. If the plurality of related records 104 have not been altered or tampered with since determining the first message digest 202, the second message digest 204 should match the first message digest 202. At operation 410, the method 400 includes validating the workflow 102 based on the first message digest 202 and the second message digest 204. That is, the validator 120 may validate the workflow 102 when the first message digest 202 and the second message digest 204 match (e.g., indicating that the plurality of related records 104 have not changed). At operation 412, the method 400 includes executing the workflow 102 based on validating the workflow 102.

Accordingly, the validator 120 ensures the integrity and authenticity of the plurality of related records 104 associated with the workflow 102. The validator 120 verifies the relationships and dependencies among the related records 104, which are not captured by traditional methods that focus on securing individual records. As such, the validator 120 reduces the computational and storage overhead of the validation process by using message digests 202, 204 and signing only the master record 108 that includes information about the workflow 102 and the related records 104.

Traditional methods often require each individual record to be signed and verified, which is computationally expensive and inefficient, especially for large datasets. By contrast, the validator 120 generates the first message digest 202 based on the plurality of related records 104 and stores the first message digest 202 in the master record 108. The encryption module 150 signs the master record 108 with the digital signature 152, ensuring the integrity of the entire dataset without the need to sign each related record individually. As such, the validator 120 not only saves computational resources but also simplifies the validation process, making it more efficient and scalable for large and dynamic datasets. As a result, the validator 120 provides comprehensive record integrity that verifies the entire dataset as a whole, rather than individual records, and ensures that the workflow operates correctly and securely. In some scenarios, the encryption module 150 may validate the digital signature 152 of the signed master record 108S before validating the workflow 102 to provide added verification.

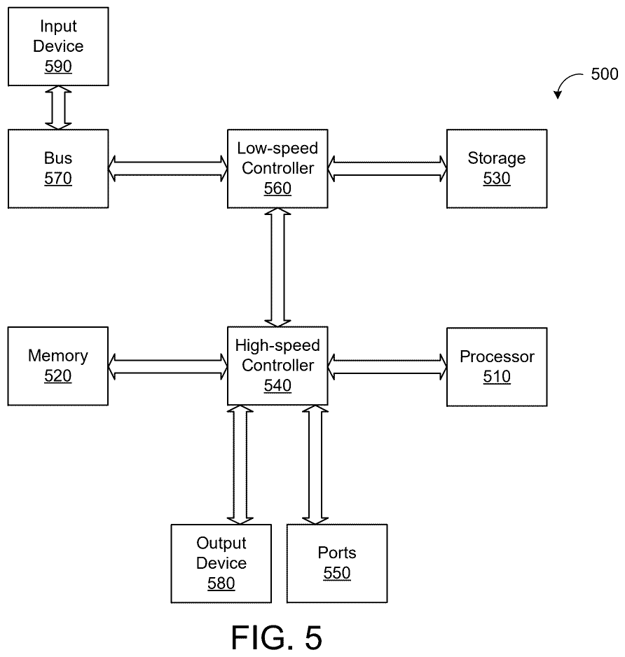

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non-transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer.

Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
determining a first message digest based on a plurality of related records associated with a workflow;
storing the first message digest and the plurality of related records at a database;
receiving a request to execute the workflow; and
based on receiving the request to execute the workflow:
determining a second message digest based on the plurality of related records stored at the database;
validating the workflow based on the first message digest and the second message digest; and
based on validating the workflow, executing the workflow.

2. The method of claim 1, further comprising:
adding the first message digest to a master record associated with the workflow; and
signing the master record with a digital signature.

3. The method of claim 2, wherein the digital signature comprises an asymmetric key.

4. The method of claim 2, further comprising, based on receiving the request to execute the workflow, validating the digital signature of the master record.

5. The method of claim 4, wherein validating the workflow is further based on validating the digital signature of the master record.

6. The method of claim 1, wherein each respective related record of the plurality of related records comprises one or more respective field values.

7. The method of claim 6, wherein the one or more respective field values are stored at one or more tables.

8. The method of claim 6, further comprising, for each respective related record of the plurality of related records, generating a respective field value concatenation based on the one or more respective field values.

9. The method of claim 8, wherein determining the first message digest comprises generating a record concatenation based on each respective field value concatenation generated for the plurality of related records.

10. The method of claim 1, further comprising:
receiving a second request to execute the workflow; and
based on receiving the second request to execute the workflow:
determining a third message digest based on the plurality of related records stored at the database; and
invalidating the workflow based on the first message digest and the third message digest.

11. The method of claim 1, wherein the workflow is associated with a no-code flow diagram.

12. The method of claim 1, wherein the workflow is associated with a software script.

13. A system comprising:
data processing hardware; and
memory hardware in communication with the data processing hardware, the memory hardware storing instructions that when executed on the data processing hardware cause the data processing hardware to perform operations comprising:
determining a first message digest based on a plurality of related records associated with a workflow;
storing the first message digest and the plurality of related records at a database;
receiving a request to execute the workflow; and
based on receiving the request to execute the workflow:
determining a second message digest based on the plurality of related records stored at the database;
validating the workflow based on the first message digest and the second message digest; and
based on validating the workflow, executing the workflow.

14. The system of claim 13, wherein the operations further comprise:
adding the first message digest to a master record associated with the workflow; and
signing the master record with a digital signature.

15. The system of claim 14, wherein the operations further comprise, based on receiving the request to execute the workflow, validating the digital signature of the master record.

16. The system of claim 15, wherein validating the workflow is further based on validating the digital signature of the master record.

17. The system of claim 13, wherein each respective related record of the plurality of related records comprises one or more respective field values.

18. The system of claim 17, wherein the one or more respective field values are stored at one or more tables.

19. The system of claim 13, wherein the operations further comprise:
receiving a second request to execute the workflow; and
based on receiving the second request to execute the workflow:
determining a third message digest based on the plurality of related records stored at the database; and
invalidating the workflow based on the first message digest and the third message digest.

20. A computer-readable medium having instructions that, when executed by data processing hardware, causes the data processing hardware to perform operations comprising:
determining a first message digest based on a plurality of related records associated with a workflow;
storing the first message digest and the plurality of related records at a database;
receiving a request to execute the workflow; and
based on receiving the request to execute the workflow:
determining a second message digest based on the plurality of related records stored at the database;
validating the workflow based on the first message digest and the second message digest; and
based on validating the workflow, executing the workflow.
